(19) United States
(12) Patent Application Publication
(10) Pub. No.: US 2007/0140471 A1
(43) Pub. Date: Jun. 21, 2007

(54) Enhanced usage of telephone in noisy surroundings

(75) Inventor: Srinivas Gutta, Veldheven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/586,178

(22) PCT Filed: Jan. 17, 2005
(86) PCT No.: PCT/IB05/50193

§ 371 Date: Jul. 17, 2006

Related U.S. Application Data
(60) Provisional application No. 60/537,806, filed on Jan. 20, 2004.

(51) Int. Cl. H04M 1/00; H04M 9/00

(52) U.S. Cl. 379/392.01

(57) ABSTRACT

A method for enhancing a usage of a telephone (100) is provided. The method including: receiving an incoming call; detecting an ambient noise level; and enhancing the incoming call to make it more understandable by a recipient of the incoming call where the detected ambient noise level is greater than a predetermined threshold noise level. The enhancing can include automatically amplifying a loudness of the incoming call to the recipient of the incoming call and/or converting the incoming call to text and displaying the text to the recipient of the incoming call.

The present invention relates generally to telephones, and more particularly, to an enhanced usage of cellular telephones in noisy surroundings.

Telephone calls that are received in noisy surroundings are very difficult to understand because ambient noise can interfere with the ability to hear and understand an incoming call. This situation is generally encountered with all types of telephones but are more likely with cellular telephones because they can be used in environments where there is typically a lot of ambient noise, such as social gathering places, highways, worksites, etc. Cellular telephones known in the art have a manual volume control that requires a user to manually depress a button to adjust the volume of the incoming call. Such buttons are generally not dedicated to the control of the volume (i.e., they provide other functions, such as traversing through listings in a telephone number directory), therefore, it is not always clear which buttons are used for the volume control. Furthermore, a user generally has to receive the telephone call and remove the telephone from his/her ear to make the manual adjustment in the volume. These features make the use of the telephone cumbersome and cause the user to miss a portion of the telephone call.

Therefore it is an object of the present invention to provide methods and devices that overcome these and other disadvantages associated with the prior art.

Accordingly, a method for enhancing a usage of a telephone is provided. The method comprising: receiving an incoming call; detecting an ambient noise level; and enhancing the incoming call to make it more understandable by a recipient of the incoming call where the detected ambient noise level is greater than a predetermined threshold noise level. The telephone can be a cellular telephone.

The enhancing can comprise automatically amplifying a loudness of the incoming call to the recipient of the incoming call. The method can further comprise detecting whether a headphones is operatively connected to the telephone, wherein the amplifying is only carried out when the headphones are detected as being operatively connected.

The enhancing can comprise converting the incoming call to text and displaying the text to the recipient of the incoming call.

The enhancing can also comprise automatically amplifying a loudness of the incoming call to the recipient of the incoming call and converting the incoming call to text and displaying the text to the recipient of the incoming call.

Also provided is a telephone comprising: a receiver for receiving an incoming call; a noise sensor for detecting an ambient noise level; and a processor for enhancing the incoming call to make it more understandable by a recipient of the incoming call where the detected ambient noise level is greater than a predetermined threshold noise level. The telephone can be a cellular telephone.

The telephone can further comprise a speaker for reproducing the incoming call, wherein the processor automatically amplifies a loudness of the incoming call on the speaker where the detected ambient noise level is greater than the predetermined threshold noise level. The processor can further detect whether a headphone is operatively connected to the telephone, wherein the processor only amplifies the incoming call on the speaker where the headphones are detected as being operatively connected.

The telephone can further comprise a display screen for displaying alphanumeric text to the recipient of the incoming call, wherein the processor converts the incoming call to text and displays the text to the recipient of the incoming call where the detected ambient noise level is greater than the predetermined threshold noise level.

The telephone can further comprise a speaker for reproducing the incoming call and a display screen for displaying alphanumeric text to the recipient of the incoming call, wherein the processor automatically amplifies a loudness of the incoming call on the speaker, converts the incoming call to text, and displays the text to the recipient of the incoming call where the detected ambient noise level is greater than the predetermined threshold noise level.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

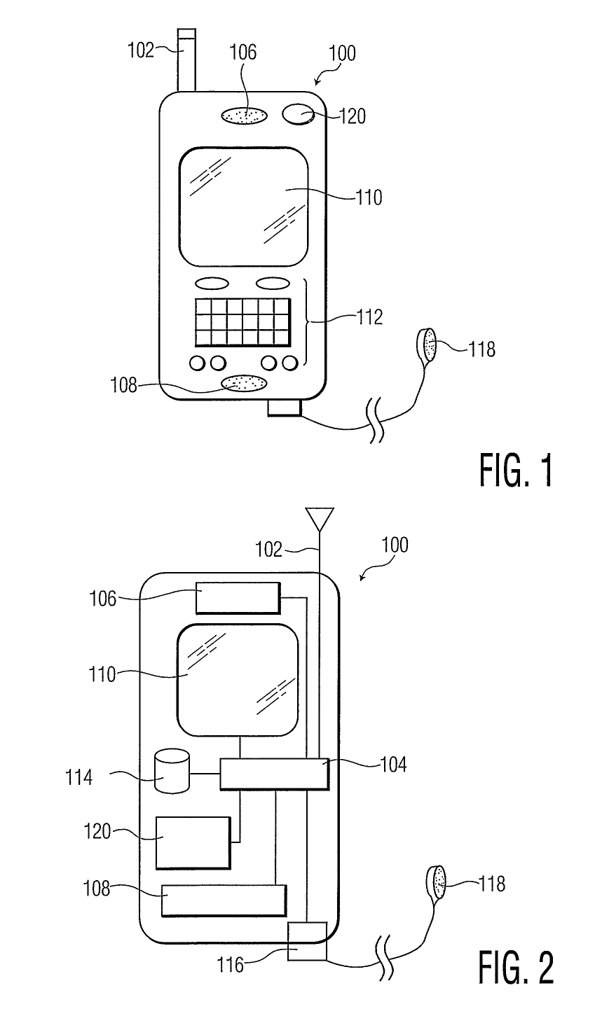

FIG. 1 illustrates a telephone of the present invention, configured as a cellular telephone.

FIG. 2 illustrates a schematic of the cellular telephone of FIG. 1.

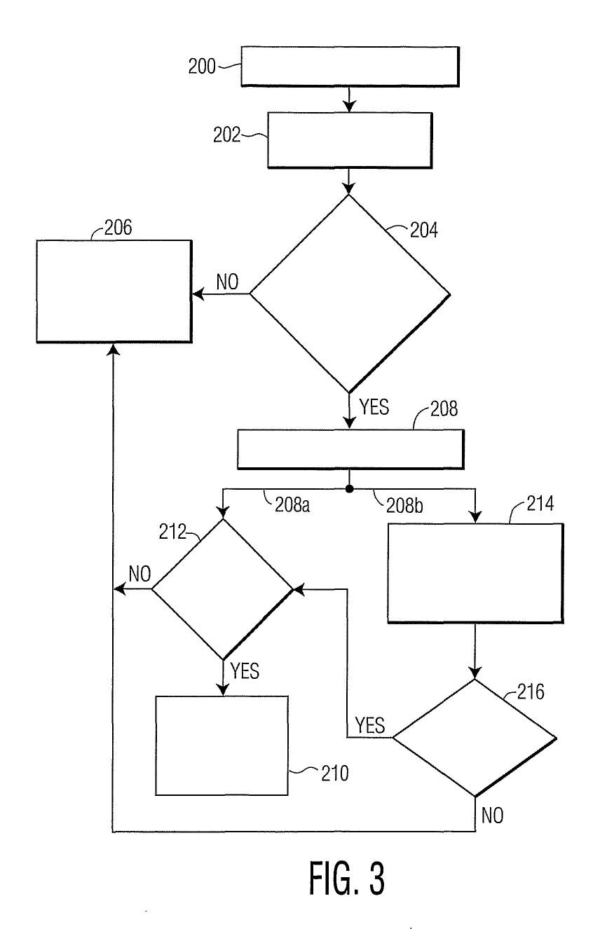

FIG. 3 illustrates a flow chart of a preferred method of the present invention.

Although this invention is applicable to numerous and various types of telephones, it has been found particularly useful in the environment of cellular telephones. Therefore, without limiting the applicability of the invention to cellular telephones, the invention will be described in such environment. However, those skilled in the art will appreciate that the methods and telephones of the present invention have application in other environments, such as cordless telephones, walkie-talkie telephones, and corded telephones.

Referring now to FIGS. 1 and 2, there is illustrated a telephone, generally referred to by reference numeral 100. As discussed above, although the telephone 100 can be any of a variety of different types of telephones known in the art, it is shown by example only configured as a cellular telephone that can receive cellular telephone call transmissions. The telephone 100 can also be configured to receive other types of telephone calls, such as cordless and corded telephone calls. The telephone 100 has a receiver for receiving an incoming call. In the case of a cellular telephone, the receiver comprises an antenna 102 that receives the cellular telephone call transmissions. Although not shown, the antenna 102 is assumed to include all necessary associated elements to receive, de-multiplex, format and otherwise convert an incoming cellular transmission such that it can be received by a recipient. Such elements and methods for their operation are well known in the art. Where the telephone 100 is a cordless or corded telephone, the receiver can be a wireless transmission (e.g., 2.4 GHz transmission) or a conventional telephone socket connector, respectively.

The telephone further has a processor 104 for controlling the normal operation of the telephone 100 as well as the methods of the present invention. The processor is operatively connected to the antenna 102 (and associated elements) and may include one or more of such associated elements. The processor 104 is also operatively connected to a speaker 106, a microphone 108, and a display screen 110. The speaker 106 is used to reproduce noise, such as a voice of a caller from an incoming call as well as other sounds associated with a normal operation of the telephone 100, such as a ringing tone or beeps. The microphone 108 is used to detect a voice of the user of the telephone 100 or other any other sound and supply the same to the processor and antenna 102 (operating as a transmitter) to transmit the same to another telephone (not shown). The display screen 110 is used to produce alphanumeric text or graphics as is known in the art. The display screen 110 can display a caller's telephone number and/or name, a time of day, programming functions and instructions, a message etc. The processor 104 is also operatively connected to a plurality of keypads/switches/buttons 112 for operating and/or programming the telephone 100 as is known in the art. The telephone 100 also includes a storage device 114 operatively connected to the processor 104 for storing data, such as telephone numbers and corresponding names and/or for storing program instructions for controlling the normal functions of the telephone 100 and/or program instructions for carrying out the methods of the present invention. The telephone 100 may also include a headphone connector 116 for connection of a headphone 118 (alternatively referred to as a hands-free device), a speakerphone (not shown), a battery (not shown), and a charging connector (not shown).

The telephone can also include a noise sensor 120 for detecting an ambient noise level. The noise sensor 120 is preferably placed on the telephone 100 so as not to be affected by the normal operation of the telephone 100. For example, the noise sensor 120 can be placed such that it is not affected by the sound reproduced on the speaker 106, the voice of the user, or the placement of the user's hand on the telephone 100. Alternatively, the microphone 108 can also serve as the noise sensor 120. The recognition of ambient noise as well as distinguishing background noise from other acceptable noise (i.e., the voice of the user) is well known in the art. As will be discussed more fully below, the noise sensor 120 is useful to enhance the incoming call to make it more understandable by a recipient of the incoming call where a detected ambient noise level is greater than a predetermined threshold noise level. As discussed below, the enhancing can comprise amplifying a loudness of the incoming call on the speaker 106 and/or converting the incoming call to text and displaying the text to the recipient of the incoming call on at least a portion of the display screen 110.

Referring now to FIG. 3, there is shown a flowchart illustrating a preferred method for enhancing a usage of the telephone 100. The method comprises receiving an incoming call at step 200. As discussed above, the receiving of the incoming call can comprise all necessary steps to process a received signal for use with the telephone 100. At step 202, an ambient noise level is detected using the noise sensor 120 (or alternatively, the microphone 108). The detection of the ambient noise level can be performed continuously or only upon receipt of an incoming call. To conserve power, the latter is preferred. At step 204, it is determined whether the detected ambient noise level is above a predetermined threshold noise level. The predetermined threshold noise level is selected such that it is difficult to hear and/or understand a telephone conversation at noise levels above the predetermined threshold noise level. The predetermined threshold noise level can be stored in the storage device 114 and may be programmable by the user. For example, the user may be particularly susceptible to ambient noise and may choose a low threshold value or a user may be able to discern a conversation even with a moderate amount of ambient noise and may choose a high threshold value. Such values may be chosen with the use of the keypads/switches/buttons 112 and display as is well known in the art. Unless otherwise changed by a user, the threshold value may default to a moderate setting which corresponds to the listening ability of an average person. The detection of the ambient noise level can only occur at the beginning of the incoming call, it can continue throughout the duration of the incoming call, or it can be done periodically during the duration of the incoming call. Of course, the detection frequency can affect the power drain on the telephone's 100 batteries. Therefore, the detection frequency can also be chosen and programmed by the user.

If the detected ambient noise level is determined not to be greater than the predetermined threshold noise level, the method proceeds to step 206 where the incoming call is reproduced on the speaker 106 at a normal level, which may also be programmed by the user. Where the detected ambient noise level is determined to be greater than the predetermined threshold noise level, the method proceeds to step 208 where the incoming call is enhanced to improve the likelihood that a user can understand the incoming call. The method can then proceed to either or both of branches 208a and 208b.

Following along branch 208a, the enhancing can comprise amplifying a loudness of the incoming call on the speaker 106 at step 210. The loudness of the call can be automatically increased at the speaker 106 or a determination can be made first at step 212. Since the increase in loudness may compromise the privacy of the incoming call, at step 212 it can first be determined whether a headphone 118 is connected to the telephone 100. If the headphones 118 are detected to be connected, the method can then proceed to step 210 where the incoming call is amplified to the headphones 118. If the headphones 118 are determined not to be connected, the method can proceed to step 206 where the incoming call is reproduced on the speaker 106 at normal levels. Such a determination can be programmed by a user who may generally desire privacy during all incoming calls. Alternatively, where the headphones are not detected, the telephone may also warn the user (e.g., on the display screen 110) that the incoming call is about to be amplified and prompt the user to use the headphones or take another action such as reproducing the incoming call on the speaker at normal levels or “dumping” the incoming call to voice mail.

Following along branch 208b, the enhancing can comprise converting the incoming call to text and displaying the text to the recipient of the incoming call at step 214. Speech recognition is well known in the art, therefore, a detailed description thereof is omitted herein. Generally, the speech recognition is carried out by the processor 104 from a set of instructions and data contained on the storage device 114. The processor 104 and storage device 114 are shown as single elements by way of example only. Those skilled in the art will appreciate that the same can be configured as two or more processors and/or storage devices. For example, the telephone can have a processor and/or storage device for carrying out the normal functions of the telephone 100 and another processor and/or storage device for carrying out some or all of the methods of the present invention.

In addition to the displaying of the text of the incoming call on the display screen 110, the user may also wish for the incoming call to be amplified on the speaker 106. This may serve as a check on the speech recognition or it may just reflect a preference of the user. The desire to enhance the incoming call with displaying the text of the incoming call on the display screen 110 and/or amplification of the incoming call on the speaker 106 can be chosen and programmed by the user as is known in the art. If it is determined that amplification is also desired at step 216, the method proceeds to step 212 (or directly to step 210) as discussed above. If amplification is not also desired, the method proceeds to step 206 where the incoming call is reproduced at a normal level on the speaker 106. Alternatively, the speaker 106 can be disabled to conserve battery power when the text corresponding to the incoming call is being displayed on the display screen 110.

The methods of the present invention are particularly suited to be carried out by a computer software program, such computer software program can contain modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for enhancing a usage of a telephone (100), the method comprising:
receiving an incoming call;
detecting an ambient noise level; and
enhancing the incoming call to make it more understandable by a recipient of the incoming call where the detected ambient noise level is greater than a predetermined threshold noise level.

2. The method of claim 1, wherein the enhancing comprises automatically amplifying a loudness of the incoming call to the recipient of the incoming call.

3. The method of claim 1, wherein the enhancing comprises converting the incoming call to text and displaying the text to the recipient of the incoming call.

4. The method of claim 1, wherein the enhancing comprises automatically amplifying a loudness of the incoming call to the recipient of the incoming call and converting the incoming call to text and displaying the text to the recipient of the incoming call.

5. The method of claim 1, wherein the telephone is a cellular telephone (100).

6. The method of claim 2, further comprising detecting whether a headphones (118) is operatively connected to the telephone (100), wherein the amplifying is only carried out when the headphones are detected as being operatively connected.

7. A telephone (100) comprising:
a receiver (102) for receiving an incoming call;
a noise sensor (120) for detecting an ambient noise level; and
a processor (104) for enhancing the incoming call to make it more understandable by a recipient of the incoming call where the detected ambient noise level is greater than a predetermined threshold noise level.

8. The telephone of claim 7, further comprising a speaker (106) for reproducing the incoming call, wherein the processor (104) automatically amplifies a loudness of the incoming call on the speaker where the detected ambient noise level is greater than the predetermined threshold noise level.

9. The telephone of claim 7, further comprising a display screen (110) for displaying alphanumeric text to the recipient of the incoming call, wherein the processor (104) converts the incoming call to text and displays the text to the recipient of the incoming call where the detected ambient noise level is greater than the predetermined threshold noise level.

10. The telephone of claim 7, further comprising a speaker (106) for reproducing the incoming call and a display screen (110) for displaying alphanumeric text to the recipient of the incoming call, wherein the processor (104) automatically amplifies a loudness of the incoming call on the speaker, converts the incoming call to text, and displays the text to the recipient of the incoming call where the detected ambient noise level is greater than the predetermined threshold noise level.

11. The telephone of claim 7, wherein the telephone is a cellular telephone (100).

12. The telephone of claim 8, wherein the processor (104) further detects whether a headphones (118) is operatively connected to the telephone (100), wherein the processor (104) only amplifies the incoming call on the speaker (106) where the headphones are detected as being operatively connected.

13. A computer program product embodied in a computer-readable medium for enhancing a usage of a telephone (100), the computer program product comprising:
computer readable program code means for receiving an incoming call;
computer readable program code means for detecting an ambient noise level; and
computer readable program code means for enhancing the incoming call to make it more understandable by a recipient of the incoming call where the detected ambient noise level is greater than a predetermined threshold noise level.

14. The computer program product of claim 13, wherein the computer readable program code means for enhancing comprises computer readable program code means for automatically amplifying a loudness of the incoming call to the recipient of the incoming call.

15. The computer program product of claim 13, wherein the computer readable program code means for enhancing comprises computer readable program code means for converting the incoming call to text and displaying the text to the recipient of the incoming call.

16. A program storage device readable by machine, tangibly embodying a program of instructions executable by the machine to perform method steps for enhancing a usage of a telephone (100), the method comprising:
receiving an incoming call;
detecting an ambient noise level; and
enhancing the incoming call to make it more understandable by a recipient of the incoming call where the detected ambient noise level is greater than a predetermined threshold noise level.

17. The program storage device of claim 16, wherein the enhancing comprises automatically amplifying a loudness of the incoming call to the recipient of the incoming call.

18. The program storage device of claim 16, wherein the enhancing comprises converting the incoming call to text and displaying the text to the recipient of the incoming call.
